(19) United States
(12) Patent Application Publication
(10) Pub. No.: US 2026/0277414 A1
(43) Pub. Date: Sep. 17, 2026

(54) METHOD AND APPARATUS FOR SLIDING IMAGE PREVIEW AND TERMINAL DEVICE

(71) Applicant: Beijing Zitiao Network Technology Co., Ltd., Beijing (CN)

(72) Inventor: Yuande LIU, Beijing (CN)

(21) Appl. No.: 19/473,478

(22) PCT Filed: Apr. 9, 2024
(86) PCT No.: PCT/CN2024/086835

§ 371 Date: Oct. 7, 2025

(30) Foreign Application Priority Data
Apr. 10, 2023 (CN) 202310377002.1

(51) Int. Cl. G06F 3/04845; G06T 3/4038; G06T 7/11; G06T 7/70

(52) U.S. Cl. CPC G06F 3/04845; G06T 3/4038; G06T 7/11; G06T 7/70; G06T 2207/20132

(57) ABSTRACT

The embodiments of the present disclosure relate to a method and an apparatus for sliding image preview and a terminal device. The method includes: acquiring, in response to a slide-to-switch operation for images in an image set being detected, index information of at least one image to be presented corresponding to a switching operation process; extracting a thumbnail corresponding to the index information according to the index information; presenting, in response to the thumbnail being rendered, the thumbnail in a first presentation area in an image preview area; acquiring an original image corresponding to the index information, and decoding and rendering the original image; and switching the thumbnail presented in the first presentation area to the original image for presentation in response to the original image being rendered successfully.

### CROSS-REFERENCE TO RELATED APPLICATIONS

The present application is based on and claims priority to China Patent Application No. 202310377002.1, filed on Apr. 10, 2023, the disclosure of which is hereby incorporated herein in its entirety.

### TECHNICAL FIELD

The embodiments of the present disclosure relate to the field of computer technology, and in particular to a method and an apparatus for sliding image preview and a terminal device.

### BACKGROUND

In a scheme where a screen progress bar is slid to quickly preview images, if a sliding rate is too fast, an image switching at a high frequency will occur, and in this case, a black screen phenomenon will easily occur.

### SUMMARY

The disclosure provides a method and an apparatus for sliding image preview and a terminal device.

In a first aspect, the present disclosure provides a method for sliding image preview, comprising:
acquiring, in response to a slide-to-switch operation for images in an image set being detected, index information of at least one image to be presented corresponding to a switching operation process, the image to be presented being an image in the image set;
extracting a thumbnail corresponding to the index information according to the index information;
presenting, in response to the thumbnail being rendered, the thumbnail in a first presentation area in an image preview area;
acquiring an original image corresponding to the index information, and decoding and rendering the original image;
switching the thumbnail presented in the first presentation area to the original image for presentation in response to the original image being rendered successfully.

In a second aspect, the present disclosure provides an apparatus for sliding image preview, comprising:
a detecting module configured to detect a slide-to-switch operation for images in an image set;
an acquiring module configured to acquire, in response to the detecting module detecting the slide-to-switch operation for the images in the image set, index information of at least one image to be presented corresponding to a switching operation process, the image to be presented being an image in the image set;
a processing module configured to extract a thumbnail corresponding to the index information according to the index information;
a rendering module configured to render the thumbnail;
a displaying module configured to present the thumbnail in a first presentation area in an image preview area;
the acquiring module is further configured to acquire an original image corresponding to the index information;
a decoding module configured to decode the original image;
the rendering module is further configured to render the original image;
the processing module is further configured to switch the thumbnail presented in the first presentation area to the original image in response to the original image being rendered successfully;
the displaying module is further configured to present the original image.

In a third aspect, there is provided a terminal device comprising a processor and a memory;
the memory is configured to store a computer program;
the processor is configured to implement the method for sliding image preview in any one of the embodiments in the first aspect when executing the program stored in the memory.

In a fourth aspect, there is provided a computer-readable storage medium having a computer program stored thereon, which, when executed by a terminal device, implements the method for sliding image preview in any one of the embodiments in the first aspect.

### BRIEF DESCRIPTION OF THE DRAWINGS

FIG. 1 is a schematic diagram of a page display for sliding image preview provided by a prior art;

FIG. 2 is a schematic flow chart of a method for sliding image preview provided by an embodiment of the present disclosure;

FIG. 3 is a schematic diagram of temporarily displaying a placeholder image corresponding to a thumbnail in a first presentation area before an original image is not rendered successfully provided by the present disclosure;

FIG. 4 is a schematic flow chart of another method for sliding image preview provided by an embodiment of the present disclosure;

FIG. 5 is a schematic flow chart of another method for sliding image preview provided by an embodiment of the present disclosure;

FIG. 6 is a schematic structural diagram of an apparatus for sliding image preview provided by an embodiment of the present disclosure; and

FIG. 7 is a schematic structural diagram of a terminal device provided by an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are some of the embodiments of the present disclosure, not all of the embodiments. Based on the embodiments in the present disclosure, all other embodiments obtained by ordinary skills in the art without creative efforts are within the scope claimed by the present disclosure.

It is understood that, before using the technical solutions disclosed in the respective embodiments of the present disclosure, types, usage scopes, usage scenarios, etc. of personal information involved in the present disclosure should be informed to users and authorization from the users should be obtained in an appropriate manner in accordance with relevant laws and regulations.

For example, in response to receiving an active request from a user, a prompt message is sent to the user to clearly prompt the user that the operation requested by the user to be performed will require acquiring and using personal information of the user. Thus, the user may autonomously choose whether to provide personal information to software or hardware such as a terminal device, an application, a server, or a storage medium that performs operations of the technical solutions of the present disclosure according to the prompt message.

As an optional but non-limiting implementation, in response to receiving an active request from a user, the way to send prompt information to the user may be, for example, in the form of a pop-up window, in which the prompt information may be presented in text form. In addition, the pop-up window may also carry a selection control for the user to choose “agree” or “disagree” to provide personal information to the terminal device.

It is understood that the above process for notification and acquisition of authorization from the user are merely illustrative and do not constitute a limitation on the implementation of the present disclosure. Other means that meet relevant laws and regulations may also be applied to the implementation of the present disclosure.

It is understood that the data involved in the present technical solutions (including but not limited to the data itself, the acquisition or use of the data) shall comply with requirements of pertinent laws, regulations and relevant provisions.

To facilitate understanding of the embodiments of the present disclosure, further explanations will be made below using specific embodiments in conjunction with the accompanying drawings, and these embodiments do not constitute a limitation on the embodiments of the present disclosure.

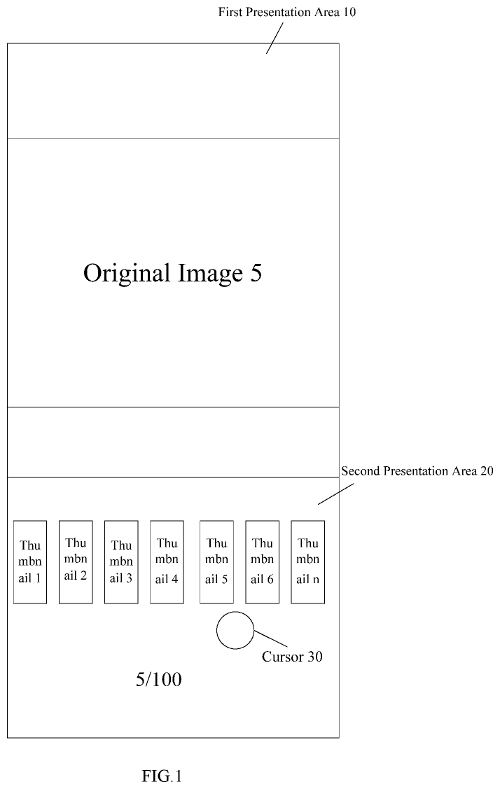

In a specific application scenario, such as presenting an image portfolio, in a specific example, an image may include a picture or a video. Taking a picture as an example, there may be up to 100 presented pictures in the presented image portfolio, for example. When a screen progress bar is slid to quickly preview the pictures in the image portfolio, this can be implemented by sliding the progress bar control at the bottom of the screen. As an example, a thumbnail list is adopted as the progress bar control, the thumbnail list may present more than ten pictures at one time, and at the same time a selected picture is enlarged and a large image of the selected picture is presented in a large image presentation area on the page. When a finger slides on positions on the thumbnail list, large images of the pictures are presented sequentially on the large image presentation area, and at the same time, the thumbnail list at the bottom moves along the opposite direction to a sliding direction of the finger. When the finger moves from a left end to a right end of the progress bar, the thumbnail list is slid to the last picture toward the left, and original images (i.e. large images) of the image portfolio are presented sequentially on the large image presentation area. For details, FIG. 1 may be referred to.

FIG. 1 schematically shows two presentation areas, wherein a first presentation area 10 is used to present a large image, and a second presentation area 20 is used to present a thumbnail list. In the related art, an original image is, after being downloaded, scaled down and presented as a thumbnail in the thumbnail list. For example, several large images are loaded in advance and then presented in the first presentation area 10, and thumbnails corresponding to the original images are presented in the second presentation area 20 as a picture preview. When a user needs to view other pictures, he needs to send a request to load thumbnails and large images. As known from the display in FIG. 1, 100 thumbnails are included in the thumbnail list, and a cursor 30 is indicating the fifth thumbnail at present, so a large image corresponding to the fifth thumbnail is also presented in the first presentation area 10 accordingly. Of course, what has been downloaded at present is the fifth picture, and if subsequent pictures need to be viewed, they may only be presented after being downloaded.

In an interactive mode where the thumbnail list at the bottom moves along the opposite direction to the sliding direction of the finger, there is a scenario where a picture switching at a high frequency occurs when the pictures are slid quickly. In the related art, a picture switching needs to go through following three operation steps, the first is to request an original image of the picture via a network interface, the second is to encode and decode the picture, and the third is to render a new picture to a screen. It may take tens of milliseconds to hundreds of milliseconds to switch pictures once due to different network speeds. In a case of poor network speeds, it even takes several seconds to present the picture. At this time, the large image presentation area is shown as a black screen, and the display effect is poor. Taking FIG. 1 as an example, in the process of performing a picture sliding operation by the user, the first presentation area 10 will display a black screen because the original image has not been loaded completely.

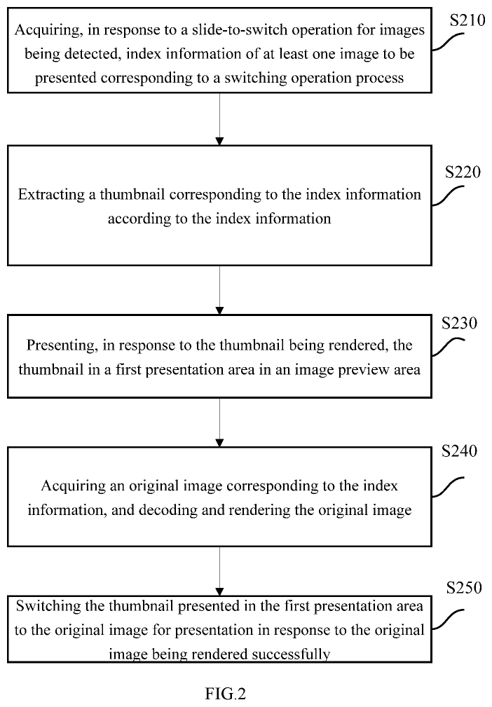

Therefore, an embodiment of the present application provides a method for sliding image preview, which is used to solve the above technical problem. For details, the following method operations and the corresponding drawings provided by the embodiment of the present disclosure may be referred to, and FIG. 2 is a schematic flow chart of a method for sliding image preview provided by an embodiment of the present disclosure. The method comprises following steps.

In operation S210, in response to a slide-to-switch operation for images being detected, index information of at least one image to be presented corresponding to a switching operation process is acquired.

Specifically, the slide-to-switch operation for the images is performed in the second presentation area mentioned above. A thumbnail list is presented in the second presentation area. It should be noted that in the present application, the thumbnail list is a thumbnail list composed of a plurality of thumbnails to be mentioned below. In the present application, the thumbnail is not a large image, but a thumbnail corresponding to a large image, acquired from a merged thumbnail downloaded from a server in advance. In this way, the loading time is shorter compared with the large image, and it will be presented in the second presentation area in a shorter time. Specifically, the image to be presented is an image in the image set.

When a user carries out the switching operation for images by sliding thumbnails in the thumbnail list with for example a finger/electronic stylus, etc., a system may automatically acquire the index information of the image to be presented. The image to be presented here is also the thumbnail that the user has clicked with the finger/electronic stylus. As an example, it can also refer to the original image corresponding to the thumbnail. Each of the images to be presented has its own index information, for example number information, etc.

In operation S220, a thumbnail corresponding to the index information is extracted according to the index information.

In operation S230, in response to the thumbnail being rendered, the thumbnail is presented in a first presentation area in an image preview area.

Specifically, in response to the thumbnail being rendered, the thumbnail is presented in the first presentation area in the image preview area, in order to prevent an occurrence of the black screen phenomenon for the mobile phone. Since the thumbnails are downloaded in advance, in the present application, it is only required to extract the thumbnails from storage locations thereof according to the index information and perform the rendering operations. The whole process may only take a few milliseconds, which is not perceived by the user from a visual perspective. From the user's perspective, when the user slides to a specific thumbnail, the thumbnail has been presented in the first presentation area. It is equivalent to using a thumbnail as a placeholder for the first presentation area to avoid the occurrence of the black screen phenomenon.

In an optional implementation, the thumbnail presented in the first presentation area is an enlarged thumbnail, that is, an placeholder image of the thumbnail is displayed, and the size may be the same as that of an original image acquired subsequently.

In operation S240, an original image corresponding to the index information is acquired, and the original image is decoded and rendered.

Specifically, the original image and the thumbnail corresponding to the original image share the same index information, so the thumbnail may be acquired according to the index information, and also the original image may be acquired according to the index information.

Moreover, the operation for acquiring the thumbnail and the operation for acquiring the original image can be performed in parallel, and while the thumbnail is extracted, the downloading operation, rendering operation, etc. for the original image are performed. This facilitates presenting the original image in the first presentation area timely after the completion of downloading and rendering the original image.

In operation S250, the thumbnail presented in the first presentation area is switched to the original image for presentation in response to the original image being rendered successfully.

Specifically, the original image is decoded after being acquired, and then after the rendering operation is performed, the thumbnail in the first presentation area may be replaced with the original image for presentation. In this way, it is convenient for the user to view and the display effect is improved.

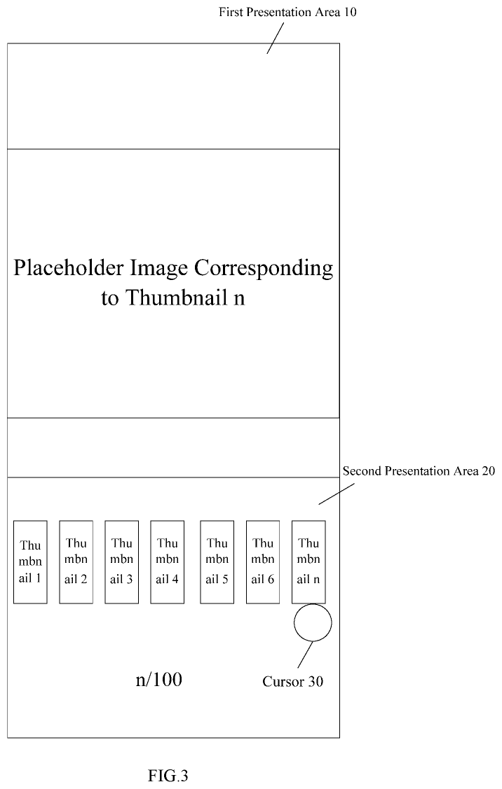

For details, FIG. 3 may be referred to, which shows a schematic diagram of temporarily displaying the placeholder image corresponding to the thumbnail in the first presentation area before the original image is not rendered successfully. In FIG. 3, the placeholder image corresponding to the nth thumbnail is displayed, wherein n is a positive integer.

In the method for sliding the image preview provided by the embodiment of the present disclosure, in response to a slide-to-switch operation for images in an image set being detected, index information of at least one image to be presented corresponding to a switching operation process is acquired. Then, a thumbnail corresponding to the index information is extracted according to the index information. In response to the thumbnail being rendered, the thumbnail is presented first in a first presentation area in an image preview area. After an original image corresponding to the index information is acquired, the original image is decoded and rendered, and the thumbnail presented in the first presentation area is switched to the original image for presentation in response to the original image being rendered successfully. Thus, the occurrence of the black screen phenomenon when images in the image set are quickly switched can be avoided, and the display effect when the user browses images may be improved.

In some embodiments, a merged thumbnail refers to an image formed by merging a plurality of small images onto a large image. As introduced above, the merged thumbnail will be downloaded to the terminal device in advance. Once the slide-to-switch operation for the images is detected, a position where the thumbnail corresponding to the index information is located may be determined from a pre-configured merged thumbnail according to the index information, and then the thumbnail may be cropped from the merged thumbnail according to the position information.

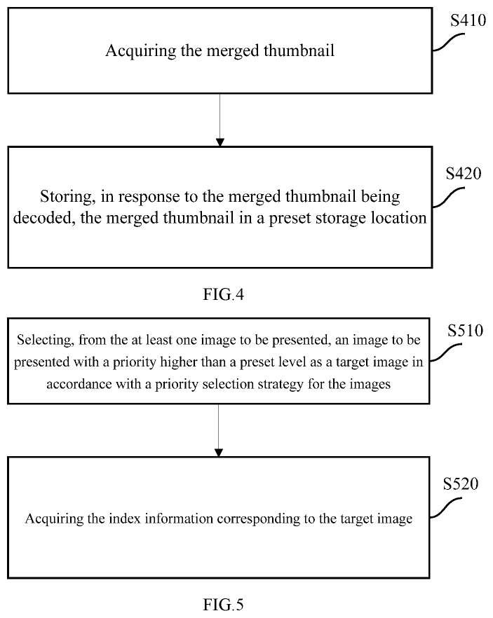

Further optionally, as introduced above, the merged thumbnail is downloaded to the terminal device in advance, so before the extracting the thumbnail corresponding to the index information according to the index information, the method further includes the following operations, which, as specifically shown in FIG. 4, includes:

In operation S410, the merged thumbnail is acquired.

Specifically, the merged thumbnail is pre-configured in a server, and the user may acquire the merged thumbnail from the server as needed.

In operation S420, in response to the merged thumbnail being decoded, the merged thumbnail is stored in a preset storage location.

Specifically, the terminal is required to decode the merged thumbnail and then store it in the preset storage location. After that, the terminal device may find and crop a thumbnail in the merged thumbnail according to the index information, and display the thumbnail in the first presentation area after the rendering work is completed.

Further optionally, considering a situation in which a switching frequency is higher than a preset image refresh frequency when the user slides to switch images. For example, for an image portfolio including 100 images, in one sliding process, if the finger slides a distance of 120 px in 100 ms, then 12 images need to be presented, that is, 12 image switches occur in 100 ms, at this moment, the frame rate of the image switching is 12/0.1 s, i.e., the frame rate fps is 120 Hz. In a case where currently the screen refresh frame rate of the mainstream flagship mobile phone is 60 Hz, half of the image switches can't be rendered on the screen even if the images have been loaded, that is, half of the image switches belongs to noneffective loading. Therefore, in the present solution, the image switches that are more than the screen refresh frame rate need to be discarded according to the refresh frame rate of the mobile phone screen, i.e., frames are discarded. Or alternatively, if the sliding is very quick and 12 images need to be presented, but only 2 images can be presented, it is required to select two images from the 12 images for presentation, i.e., frames are extracted. When there is a case where any of discarding frames and extracting frames above occurs, it is necessary to select a target image from a plurality of images to be presented for presentation. The specific images to be presented need to be selected through a priority selection strategy.

That is, in response to the image switching frequency being higher than a preset image refresh frame rate, the method further includes the following operations, which, as specifically shown in FIG. 5, includes:

In operation S510, an image to be presented with a priority higher than a preset level is selected as a target image from the at least one image to be presented in accordance with a priority selection strategy for the images.

In operation S520, the index information corresponding to the target image is acquired.

After the index information corresponding to the target image is acquired, operations similar to operations S220 to S250 are performed, which is equivalent to presenting only the thumbnail corresponding to the target image in the first presentation area, and presenting the original image corresponding to the target image in the first presentation area after the original image corresponding to the target image is rendered successfully. The specific operation process will not be repeated here.

In some embodiments, the priority selection strategy includes one or more of the following:

The first is to make an image selected when the slide-to-switch operation for the images is stopped have a highest priority.

The second is to sort priorities of the images to be presented according to loading stages for the original images corresponding to the images to be presented, wherein the later the loading stage is, the higher the priority is.

The third is to sort priorities of a plurality of images to be presented in accordance with sizes of the original images of the individual images to be presented when the original images respectively corresponding to the plurality of images to be presented are in the same loading stage, wherein the smaller the original image is, the higher the priority is.

Specifically, the image selected when the sliding is stopped has the highest priority. When only one image is selected, the image selected when the sliding is stopped may be selected as the target image, and the index information of the target image may be acquired, and then the thumbnail may be acquired according to the index information to be presented in the first presentation area. Moreover, in terms of the loading stages where the original images corresponding to the images to be presented are currently in, the image in the late loading stage has a higher priority than the image in the early loading stage. For example if the original image corresponding to the image A to be presented is currently in a network request stage and the original image corresponding to the image B to be presented is in an encoding/decoding stage, then the image B to be presented has a higher priority. Since the final loading time for the original image corresponding to the image B to be presented is shorter than that for the image A to be presented, the rationale behind this strategy is that the image with a short loading time is preferentially loaded. In some special cases, when the original images respectively corresponding to a plurality of images to be presented are in the same loading stage, the smaller image has a higher priority. The rationale behind this strategy is that if an image is smaller, the loading time in subsequent stages will be shorter, so it is preferentially loaded. The plurality of images to be presented are sorted by priority according to the priority selection strategy above, and then a preset number of images to be presented are selected as target images from the sorted sequence.

Further optionally, as introduced above, the image preview area further includes a second presentation area, and the second presentation area is used to present thumbnails corresponding to a plurality of images to be presented in the image set. Therefore, the priority selection strategy further includes:
determining that an image to be presented in the image set that is closer to the image to be presented at a left or right endpoint in the image set has a higher priority, wherein the image to be presented at the left endpoint and the image to be presented at the right endpoint in the image set have the same priority;
making a first image to be presented and a second image to be presented have the same priority when a distance from the first image to be presented to the image to be presented at the left endpoint is the same as a distance from the second image to be presented to the image to be presented at the right endpoint, wherein the first image to be presented and the second image to be presented are any two thumbnails in the image set.

Specifically, in a series of images in the image set, the images at two end positions have higher priority than at the middle position. For example, if the images indexed from 21 to 25 need to be loaded, the priorities of the images indexed from 21 to 25 are as follows:

$$21 > 22 > 23 < 24 < 25.$$

The rationale behind this strategy is that, in one sliding process, the user will be more impressed with the images at the beginning and at the end of the sliding, while the ones in the middle are relatively easy to be ignored, so the presentations of the images at the front and back ends are preferentially ensured and the images in the middle are discarded.

Through the above strategy, according to the screen refresh frame rate and the sliding speed, the frames can be extracted or discarded following a certain strategy in conjunction with loading situation of the original image corresponding to the image to be presented and the position where the image to be presented is located, which reduces the occurrence of noneffective image loading and further reduces the loss caused to the performance of the mobile phone.

The above are the method embodiments corresponding to sliding image preview provided by the present disclosure, and other embodiments corresponding to sliding image preview provided by the present disclosure will introduced below. The details are as follows.

FIG. 6 is a schematic structural diagram of an apparatus for sliding image preview provided by an embodiment of the present disclosure. The apparatus includes a detecting module 601, an acquiring module 602, a processing module 603, a rendering module 604, a displaying module 605, and a decoding module 606.

The detecting module 601 is configured to detect a slide-to-switch operation for images in an image set.

The acquiring module 602 is configured to acquire, in response to the detecting module 601 detecting the slide-to-switch operation for the images in the image set, index information of at least one image to be presented corresponding to a switching operation process, the image to be presented being an image in the image set.

The processing module 603 is configured to extract a thumbnail corresponding to the index information according to the index information.

The rendering module 604 is configured to render the thumbnail.

The displaying module 605 is configured to present the thumbnail in a first presentation area in an image preview area.

The acquiring module 602 is further configured to acquire an original image corresponding to the index information.

The decoding module 606 is configured to decode the original image.

The rendering module 604 is further configured to render the original image.

The processing module 603 is further configured to replace the thumbnail in the first presentation area in response to the original image being rendered successfully.

The displaying module 605 is further configured to present the original image.

Optionally, the processing module 603 is specifically configured to determine a position where the thumbnail is located from a pre-configured merged thumbnail, the merged thumbnail being an image obtained by merging thumbnails corresponding to all images in the image set; and crop the thumbnail from the merged thumbnail according to the position where the thumbnail is located.

Optionally, the acquiring module 602 is further configured to acquire the merged thumbnail.

The decoding module 606 is configured to store, in response to the merged thumbnail being decoded, the merged thumbnail in a preset storage location.

Optionally, in response to an image switching frequency being higher than a preset image refresh frame rate, the processing module 603 is further configured to select, from the at least one image to be presented, an image to be presented with a priority higher than a preset level as a target image in accordance with a priority selection strategy for the images.

The acquiring module 602 is further configured to acquire the index information corresponding to the target image.

Optionally, the priority selection strategy includes one or more of the following:
making an image selected when the slide-to-switch operation for the images is stopped have a highest priority;
sorting priorities of the images to be presented according to loading stages for the original images corresponding to the images to be presented, wherein the later the loading stage is, the higher the priority is;
sorting priorities of a plurality of images to be presented in the light of a size of the original image of each of the images to be presented when original images respectively corresponding to the plurality of images to be presented are in the same loading stage, wherein the smaller the original image is, the higher the priority is.

Optionally, the image preview area further includes a second presentation area.

The second presentation area is used to present thumbnails corresponding to a plurality of images to be presented in the image set.

Optionally, the priority selection strategy further includes:
determining that an image to be presented in the image set that is closer to the image to be presented at a left or right endpoint in the image set has a higher priority, wherein the image to be presented at the left endpoint and the image to be presented at the right endpoint in the image set have the same priority;
making a first image to be presented and a second image to be presented having the same priorities when a distance between the first image to be presented to the image to be presented at the left endpoint is the same as a distance between the second image to be presented to the image to be presented at the right endpoint, wherein the first image to be presented and the second image to be presented are any two thumbnails in the image set.

The functions performed by various components in the apparatus for sliding image preview provided by the embodiment of the present disclosure have been described in detail in the above embodiments, and thus they will not be repeated here.

The apparatus for sliding the image preview provided by the embodiment of the present disclosure acquires, in response to a slide-to-switch operation for images in an image set being detected, index information of at least one image to be presented corresponding to a switching operation process. Then, a thumbnail corresponding to the index information is extracted according to the index information. In response to the thumbnail being rendered, the thumbnail is presented first in a first presentation area in an image preview area. After an original image corresponding to the index information is acquired, the original image is decoded and rendered, and the thumbnail presented in the first presentation area is switched to the original image for presentation in response to the original image being rendered successfully. Thus, the occurrence of the black screen phenomenon when images in the image set are quickly switched can be avoided, and the display effect when the user browses images may be improved.

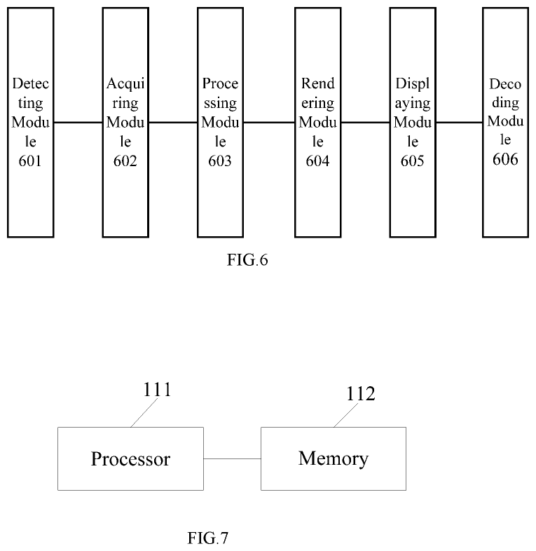

As shown in FIG. 7, an embodiment of the present disclosure provides a terminal device which at least includes a processor 111 and a memory 112, wherein the processor 111 and the memory 112 carry out the communication therebetween through a communication bus.

The memory 112 is configured to store a computer program.

In an embodiment of the present disclosure, the processor 111 is configured to implement the method for sliding image preview provided by any one of the foregoing embodiments when executing the program stored in the memory 112, and the method includes:
acquiring, in response to a slide-to-switch operation for images in an image set being detected, index information of at least one image to be presented corresponding to a switching operation process, the image to be presented being an image in the image set;
extracting a thumbnail corresponding to the index information according to the index information;
presenting, in response to the thumbnail being rendered, the thumbnail in a first presentation area in an image preview area;
acquiring an original image corresponding to the index information, and decoding and rendering the original image; and
switching the thumbnail presented in the first presentation area to the original image for presentation in response to the original image being rendered successfully.

Optionally, the extracting the thumbnail corresponding to the index information according to the index information specifically comprises:
determining a position where the thumbnail is located from a pre-configured merged thumbnail, the merged thumbnail being an image obtained by merging thumbnails corresponding to all images in the image set;
cropping the thumbnail from the merged thumbnail according to the position where the thumbnail is located.

Optionally, before the extracting the thumbnail corresponding to the index information according to the index information, the method further includes:
acquiring the merged thumbnail;
storing, in response to the merged thumbnail being decoded, the merged thumbnail in a preset storage location.

Optionally, in response to an image switching frequency being higher than a preset image refresh frame rate, the method further includes:

selecting, from the at least one image to be presented, an image to be presented with a priority higher than a preset level as a target image in accordance with a priority selection strategy for the images, and acquiring the index information corresponding to the target image.

Optionally, the priority selection strategy includes one or more of the following:
making an image selected when the slide-to-switch operation for the images is stopped have a highest priority;
sorting priorities of the images to be presented according to loading stages for the original images corresponding to the images to be presented, wherein the later the loading stage is, the higher the priority is;
sorting priorities of a plurality of images to be presented in accordance with sizes of the original images of the individual images to be presented when the original images respectively corresponding to the plurality of images to be presented are in the same loading stage, wherein the smaller the original image is, the higher the priority is.

Optionally, the image preview area further includes a second presentation area.

The second presentation area is used to present thumbnails corresponding to a plurality of images to be presented in the image set.

Optionally, the priority selection strategy further includes:
determining that an image to be presented in the image set that is closer to the image to be presented at a left or right endpoint in the image set has a higher priority, wherein the image to be presented at the left endpoint and the image to be presented at the right endpoint in the image set have the same priority;
making a first image to be presented and a second image to be presented have the same priority when a distance from the first image to be presented to the image to be presented at the left endpoint is the same as a distance from the second image to be presented to the image to be presented at the right endpoint, wherein the first image to be presented and the second image to be presented are any two thumbnails in the image set.

The embodiment of the present disclosure also provides a computer-readable storage medium having a computer program stored thereon, which, when executed by a terminal device, implements the method for sliding image preview as provided by the foregoing method embodiments.

It should be noted that, here, relational terms such as “first” and “second” are only used to distinguish one entity or operation from another entity or operation, and do not necessarily require or imply any such actual relationship or order existing between these entities or operations. Moreover, the terms “comprise”, “include” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, elements defined by the sentence “comprise a/an . . . ” do not exclude the existence of other elements in the process, method, article or device including the elements.

The above are only specific embodiments of the present disclosure, enabling those skilled in the art can understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments illustrated herein, but will conform to the widest scope consistent with the principles and novel features applied herein.

1. A method for sliding image preview, comprising:
acquiring, in response to a slide-to-switch operation for images in an image set, index information of at least one image to be presented corresponding to a switching operation process, the image to be presented being an image in the image set;
extracting a thumbnail corresponding to the index information according to the index information;
presenting, in response to the thumbnail being rendered, the thumbnail in a first presentation area in an image preview area;
acquiring an original image corresponding to the index information, and decoding and rendering the original image; and
switching the thumbnail presented in the first presentation area to the original image for presentation in response to the original image being rendered successfully.

2. The method according to claim 1, wherein the extracting the thumbnail corresponding to the index information according to the index information specifically comprises:
determining a position where the thumbnail is located from a pre-configured merged thumbnail, the merged thumbnail being an image obtained by merging thumbnails corresponding to all images in the image set;
cropping the thumbnail from the merged thumbnail according to the position where the thumbnail is located.

3. The method according to claim 2, wherein, before the extracting the thumbnail corresponding to the index information according to the index information, the method further comprises:
acquiring the merged thumbnail; and
storing, in response to the merged thumbnail being decoded, the merged thumbnail in a preset storage location.

4. The method according to claim 1, wherein, in response to an image switching frequency being higher than a preset image refresh frame rate, the method further comprises:
selecting, from the at least one image to be presented, an image to be presented with a priority higher than a preset level as a target image in accordance with a priority selection strategy for the images, and acquiring the index information corresponding to the target image.

5. The method according to claim 4, wherein the priority selection strategy includes one or more of the following:
making an image selected when the slide-to-switch operation for the images is stopped have a highest priority;
sorting priorities of the images to be presented according to loading stages for the original images corresponding to the images to be presented, wherein the later the loading stage is, the higher the priority is; and
sorting priorities of a plurality of images to be presented in accordance with sizes of the original images of the individual images to be presented when the original images respectively corresponding to the plurality of images to be presented are in the same loading stage, wherein the smaller the original image is, the higher the priority is.

6. The method according to claim 4, wherein the image preview area further includes a second presentation area;
the second presentation area is used to present thumbnails corresponding to a plurality of images to be presented in the image set.

7. The method according to claim 6, wherein the priority selection strategy further includes:
determining that an image to be presented in the image set that is closer to the image to be presented at a left or right endpoint in the image set has a higher priority, wherein the image to be presented at the left endpoint and the image to be presented at the right endpoint in the image set have the same priority;
making a first image to be presented and a second image to be presented have the same priority when a distance from the first image to be presented to the image to be presented at the left endpoint is the same as a distance from the second image to be presented to the image to be presented at the right endpoint, wherein the first image to be presented and the second image to be presented are any two thumbnails in the image set.

8. (canceled)

9. A terminal device, comprising:
a memory configured to store a computer program;
a processor configured to implement a method for sliding image preview when executing the program stored in the memory, the method comprising:
acquiring, in response to a slide-to-switch operation for images in an image set, index information of at least one image to be presented corresponding to a switching operation process, the image to be presented being an image in the image set;
extracting a thumbnail corresponding to the index information according to the index information;
presenting, in response to the thumbnail being rendered, the thumbnail in a first presentation area in an image preview area;
acquiring an original image corresponding to the index information, and decoding and rendering the original image; and
switching the thumbnail presented in the first presentation area to the original image for presentation in response to the original image being rendered successfully.

10. A non-transitory computer-readable storage medium having a computer program stored thereon, which, when executed by a terminal device, implements a method for sliding image preview comprising:
acquiring, in response to a slide-to-switch operation for images in an image set, index information of at least one image to be presented corresponding to a switching operation process, the image to be presented being an image in the image set;
extracting a thumbnail corresponding to the index information according to the index information;
presenting, in response to the thumbnail being rendered, the thumbnail in a first presentation area in an image preview area;
acquiring an original image corresponding to the index information, and decoding and rendering the original image; and
switching the thumbnail presented in the first presentation area to the original image for presentation in response to the original image being rendered successfully.

11. (canceled)

12. (canceled)

13. The terminal device according to claim 9, wherein the extracting the thumbnail corresponding to the index information according to the index information specifically comprises:
determining a position where the thumbnail is located from a pre-configured merged thumbnail, the merged thumbnail being an image obtained by merging thumbnails corresponding to all images in the image set;
cropping the thumbnail from the merged thumbnail according to the position where the thumbnail is located.

14. The terminal device according to claim 13, wherein, before the extracting the thumbnail corresponding to the index information according to the index information, the method further comprises:
acquiring the merged thumbnail; and
storing, in response to the merged thumbnail being decoded, the merged thumbnail in a preset storage location.

15. The terminal device according to claim 9, wherein, in response to an image switching frequency being higher than a preset image refresh frame rate, the method further comprises:
selecting, from the at least one image to be presented, an image to be presented with a priority higher than a preset level as a target image in accordance with a priority selection strategy for the images, and acquiring the index information corresponding to the target image.

16. The terminal device according to claim 15, wherein the priority selection strategy includes one or more of the following:
making an image selected when the slide-to-switch operation for the images is stopped have a highest priority;
sorting priorities of the images to be presented according to loading stages for the original images corresponding to the images to be presented, wherein the later the loading stage is, the higher the priority is; and
sorting priorities of a plurality of images to be presented in accordance with sizes of the original images of the individual images to be presented when the original images respectively corresponding to the plurality of images to be presented are in the same loading stage, wherein the smaller the original image is, the higher the priority is.

17. The terminal device according to claim 15, wherein the image preview area further includes a second presentation area;
the second presentation area is used to present thumbnails corresponding to a plurality of images to be presented in the image set.

18. The terminal device according to claim 17, wherein the priority selection strategy further includes:
determining that an image to be presented in the image set that is closer to the image to be presented at a left or right endpoint in the image set has a higher priority, wherein the image to be presented at the left endpoint and the image to be presented at the right endpoint in the image set have the same priority;
making a first image to be presented and a second image to be presented have the same priority when a distance from the first image to be presented to the image to be presented at the left endpoint is the same as a distance from the second image to be presented to the image to be presented at the right endpoint, wherein the first image to be presented and the second image to be presented are any two thumbnails in the image set.

19. The non-transitory computer-readable storage medium according to claim 10, wherein the extracting the thumbnail corresponding to the index information according to the index information specifically comprises:
determining a position where the thumbnail is located from a pre-configured merged thumbnail, the merged thumbnail being an image obtained by merging thumbnails corresponding to all images in the image set;
cropping the thumbnail from the merged thumbnail according to the position where the thumbnail is located.

20. The non-transitory computer-readable storage medium according to claim 10, wherein, in response to an image switching frequency being higher than a preset image refresh frame rate, the method further comprises:
selecting, from the at least one image to be presented, an image to be presented with a priority higher than a preset level as a target image in accordance with a priority selection strategy for the images, and acquiring the index information corresponding to the target image.

21. The non-transitory computer-readable storage medium according to claim 20, wherein the priority selection strategy includes one or more of the following:
making an image selected when the slide-to-switch operation for the images is stopped have a highest priority;
sorting priorities of the images to be presented according to loading stages for the original images corresponding to the images to be presented, wherein the later the loading stage is, the higher the priority is; and
sorting priorities of a plurality of images to be presented in accordance with sizes of the original images of the individual images to be presented when the original images respectively corresponding to the plurality of images to be presented are in the same loading stage, wherein the smaller the original image is, the higher the priority is.

22. The non-transitory computer-readable storage medium according to claim 20, wherein the image preview area further includes a second presentation area;
the second presentation area is used to present thumbnails corresponding to a plurality of images to be presented in the image set.

23. The non-transitory computer-readable storage medium according to claim 22, wherein the priority selection strategy further includes:
determining that an image to be presented in the image set that is closer to the image to be presented at a left or right endpoint in the image set has a higher priority, wherein the image to be presented at the left endpoint and the image to be presented at the right endpoint in the image set have the same priority;
making a first image to be presented and a second image to be presented have the same priority when a distance from the first image to be presented to the image to be presented at the left endpoint is the same as a distance from the second image to be presented to the image to be presented at the right endpoint, wherein the first image to be presented and the second image to be presented are any two thumbnails in the image set.
